(19) United States
(12) Patent Application Publication
(10) Pub. No.: US 2018/0269795 A1
(43) Pub. Date: Sep. 20, 2018

(54) BIDIRECTIONAL RESONANT CONVERSION CIRCUIT AND CONVERTER

(71) Applicant: HUAWEI TECHNOLOGIES CO., LTD., Shenzhen (CN)

(72) Inventors: Kui Zhou, Shenzhen (CN); Xijun Zhang, Shenzhen (CN); Grover Victor Torrico-Bascopé, Kista (SE)

(73) Assignee: HUAWEI TECHNOLOGIES CO., LTD., Shenzhen (CN)

(21) Appl. No.: 15/976,874

(22) Filed: May 11, 2018

Related U.S. Application Data
(63) Continuation of application No. PCT/CN2016/080688, filed on Apr. 29, 2016.

(30) Foreign Application Priority Data
Nov. 12, 2015 (CN) 201510772819.4

(51) Int. Cl. H02M 3/335; H02M 5/27; H02M 7/48

(52) U.S. Cl. CPC H02M 3/33584; H02M 7/4826; H02M 5/271; H02M 3/33507

(57) ABSTRACT

The present disclosure provide a bidirectional resonant conversion circuit and a converter. The bidirectional resonant conversion circuit includes a primary capacitor, three primary side bridge arms, three three-port resonant cavities, three transformers, three secondary side bridge arms, and a secondary capacitor. A first port of each three-port resonant cavity is connected to a corresponding primary side bridge arm, a second port of each three-port resonant cavity is connected to a ground terminal of a corresponding primary side bridge arm, and a third port of each three-port resonant cavity is connected to a corresponding transformer. Two ends of each secondary side bridge arm are respectively connected to two ends of the secondary capacitor, and each transformer is connected to a corresponding secondary side bridge arm.

### CROSS-REFERENCE TO RELATED APPLICATIONS

This application is a continuation of International Application No. PCT/CN2016/080688, filed on Apr. 29, 2016, which claims priority to Chinese Patent Application No. 201510772819.4, filed on Nov. 12, 2015. The disclosures of the aforementioned applications are hereby incorporated by reference in their entireties.

### TECHNICAL FIELD

The present disclosure relates to electronic technologies, and in particular, to a bidirectional resonant conversion circuit and a converter.

### BACKGROUND

Multiphase resonant converters are used more and more frequently for making high-power, high-efficiency, and high-density rectifiers. There are increasing application demands for the multiphase resonant converters in photovoltaic inverters, communication power supplies, and electric vehicles.

A three-phase resonant converter in the conventional art is shown in FIG. 1. The three-phase resonant converter includes three primary side bridge arms 101, three two-port resonant cavities 102, three transformers 103, and three secondary side bridge arms 104.

Bidirectional energy conversion can be implemented by using the three-phase resonant converter provided in the conventional art. However, as shown in FIG. 2, rectification gain curve 201 and inverse gain curve 202, that are of the three-phase resonant converter shown in FIG. 1, are inconsistent, and the inverse gain curve is not monotonic, thereby causing complex control and low reliability.

### SUMMARY

Embodiments of the present disclosure provide a bidirectional resonant conversion circuit and a converter that are aimed to resolve a problem that rectification gain curve and inverse gain curve are inconsistent.

A first aspect of the embodiments of the present disclosure provides a bidirectional resonant conversion circuit, including: a primary capacitor, three primary side bridge arms, three three-port resonant cavities, three transformers, three secondary side bridge arms, and a secondary capacitor, where

two ends of each primary side bridge arm are respectively connected to two ends of the primary capacitor, the three primary side bridge arms are in a one-to-one correspondence with the three three-port resonant cavities, and primary-side windings of the three transformers are in a one-to-one correspondence with the three three-port resonant cavities;

each three-port resonant cavity has three ports, a first port of each three-port resonant cavity is connected to a corresponding primary side bridge arm, a second port of each three-port resonant cavity is connected to a ground terminal of a corresponding primary side bridge arm, and a third port of each three-port resonant cavity is connected to a corresponding transformer; and

two ends of each secondary side bridge arm are respectively connected to two ends of the secondary capacitor, secondary-side windings of the three transformers are in a one-to-one correspondence with the three secondary side bridge arms, and each transformer is connected to a corresponding secondary side bridge arm.

With reference to the first aspect of the embodiments of the present disclosure, in a first implementation manner of the first aspect of the embodiments of the present disclosure, each three-port resonant cavity includes a first group of inductor and capacitor, a second group of inductor and capacitor, and a third group of inductor and capacitor, where

the first group of inductor and capacitor includes a first inductor and a first capacitor that are connected in series, a first end of the first group of inductor and capacitor is used as the first port of the three-port resonant cavity, and the first end of the first group of inductor and capacitor is a first end of the first capacitor or a first end of the first inductor;

the second group of inductor and capacitor includes a second inductor and a second capacitor that are connected in series, a first end of the second group of inductor and capacitor is used as the second port of the three-port resonant cavity, and the first end of the second group of inductor and capacitor is a first end of the second capacitor or a first end of the second inductor;

the third group of inductor and capacitor includes a third inductor and a third capacitor that are connected in series, a first end of the third group of inductor and capacitor is used as the third port of the three-port resonant cavity, and the first end of the third group of inductor and capacitor is a first end of the third capacitor or a first end of the third inductor; and

a second end of the first group of inductor and capacitor, a second end of the second group of inductor and capacitor, and a second end of the third group of inductor and capacitor are connected to each other.

With reference to the first aspect of the embodiments of the present disclosure or the first implementation manner of the first aspect of the embodiments of the present disclosure, in a second implementation manner of the first aspect of the embodiments of the present disclosure, each primary side bridge arm includes two semiconductor switching transistors that are connected in series in a same direction, a node between the two semiconductor switching transistors that are on the primary side bridge arm and connected in series in a same direction is a first node, and a first port of each three-port resonant cavity is connected to a first node of a corresponding primary side bridge arm.

With reference to the bidirectional resonant conversion circuit described in any one of the first aspect of the embodiments of the present disclosure to the second implementation manner of the first aspect of the embodiments of the present disclosure, in a third implementation manner of the first aspect of the embodiments of the present disclosure, each secondary side bridge arm includes two semiconductor switching transistors that are connected in series in a same direction, a node between the two semiconductor switching transistors that are on the secondary side bridge arm and connected in series in a same direction is a secondary node, and a secondary-side winding of each transformer is connected to a second node of a corresponding secondary side bridge arm.

With reference to the bidirectional resonant conversion circuit described in the second implementation manner of the first aspect of the embodiments of the present disclosure or the third implementation manner of the first aspect of the embodiments of the present disclosure, in a fourth implementation manner of the first aspect of the embodiments of the present disclosure, the semiconductor switching transistor is a metal-oxide semiconductor field-effect transistor (MOSFET), or an insulated gate bipolar transistor (IGBT).

With reference to the bidirectional resonant conversion circuit described in any one of the first aspect of the embodiments of the present disclosure to the fourth implementation manner of the first aspect of the embodiments of the present disclosure, in a fifth implementation manner of the first aspect of the embodiments of the present disclosure, each transformer includes one primary-side winding and one secondary-side winding, a third port of each three-port resonant cavity is connected to a primary-side winding of a corresponding transformer, undotted terminals of the primary-side windings of the three transformers are connected together, and undotted terminals of the secondary-side windings of the three transformers are connected together.

With reference to the bidirectional resonant conversion circuit described in any one of the first aspect of the embodiments of the present disclosure to the fourth implementation manner of the first aspect of the embodiments of the present disclosure, in a sixth implementation manner of the first aspect of the embodiments of the present disclosure, each transformer includes one primary-side winding and one secondary-side winding, a third port of each three-port resonant cavity is connected to a primary-side winding of a corresponding transformer, undotted terminals of the primary-side windings of the three transformers are connected together, and dotted terminals of the secondary-side windings of the three transformers are connected together.

With reference to the bidirectional resonant conversion circuit described in any one of the first aspect of the embodiments of the present disclosure to the fourth implementation manner of the first aspect of the embodiments of the present disclosure, in a seventh implementation manner of the first aspect of the embodiments of the present disclosure, each transformer includes one primary-side winding and one secondary-side winding, a third port of each three-port resonant cavity is connected to a primary-side winding of a corresponding transformer, dotted terminals of the primary-side windings of the three transformers are connected together, and undotted terminals of the secondary-side windings of the three transformers are connected together.

With reference to the bidirectional resonant conversion circuit described in any one of the first aspect of the embodiments of the present disclosure to the fourth implementation manner of the first aspect of the embodiments of the present disclosure, in an eighth implementation manner of the first aspect of the embodiments of the present disclosure, each transformer includes one primary-side winding and one secondary-side winding, a third port of each three-port resonant cavity is connected to a primary-side winding of a corresponding transformer, dotted terminals of the primary-side windings of the three transformers are connected together, and dotted terminals of the secondary-side windings of the three transformers are connected together.

A second aspect of the embodiments of the present disclosure provides a converter, including a power factor correction (PFC) circuit and a bidirectional resonant conversion circuit, where the power factor correction (PFC) circuit and the bidirectional resonant conversion circuit are connected in series;

the bidirectional resonant conversion circuit is the bidirectional resonant conversion circuit according to any one of claims 1 to 9; and

the power factor correction (PFC) circuit includes a power supply module and a power module, where

the power supply module is connected to the power module, and the power supply module is configured to provide electric energy for the power module; the power module includes at least one PFC circuit, each PFC circuit includes one inductor and one pair of first semiconductor switching transistors, where a first end of the inductor is connected to the power supply module, a second end of the inductor is separately connected to two ends of a primary capacitor by using the first semiconductor switching transistors, and the two ends of the primary capacitor are further connected to two ends of each primary side bridge arm of the bidirectional resonant conversion circuit; and

the power supply module includes an alternating current power supply and two second semiconductor switching transistors, where a first end of each second semiconductor switching transistor is connected to the alternating current power supply, and a second end of each second semiconductor switching transistor is connected to one of the pair of first semiconductor switching transistors of the power module.

The embodiments of the present disclosure provide a bidirectional resonant conversion circuit and a converter. The bidirectional resonant conversion circuit includes a primary capacitor, three primary side bridge arms, three three-port resonant cavities, three transformers, three secondary side bridge arms, and a secondary capacitor. A first port of each three-port resonant cavity is connected to a corresponding primary side bridge arm, a second port of each three-port resonant cavity is connected to a ground terminal of a corresponding primary side bridge arm, and a third port of each three-port resonant cavity is connected to a corresponding transformer. Two ends of each secondary side bridge arm are respectively connected to two ends of the secondary capacitor, and each transformer is connected to a corresponding secondary side bridge arm. By using the bidirectional resonant conversion circuit provided in the embodiments, bidirectional conversion can be conveniently implemented. In addition, a rectification gain curve and an inverse gain curve are almost consistent, control is easy, reliability is high, and natural current sharing can also be implemented. This avoids adding an extra current sharing circuit, thereby reducing costs.

### BRIEF DESCRIPTION OF DRAWINGS

FIG. 1 is a schematic diagram of a circuit structure of a three-phase resonant converter provided in the conventional art;

FIG. 2 is a schematic diagram of a rectification gain curve and an inverse gain curve that are of the three-phase resonant converter shown in FIG. 1;

FIG. 3 is a circuit diagram of a bidirectional resonant conversion circuit according to an embodiment of the present disclosure;

FIG. 4 is a circuit diagram of a bidirectional resonant conversion circuit according to an embodiment of the present disclosure;

FIG. 5 is a circuit diagram of a bidirectional resonant conversion circuit according to an embodiment of the present disclosure;

FIG. 6 is a rectification gain curve and an inverse gain curve that are of a bidirectional resonant conversion circuit according to an embodiment of the present disclosure;

FIG. 7 is a waveform of a current output by a bidirectional resonant conversion circuit according to an embodiment of the present disclosure; and

FIG. 8 is a circuit diagram of a converter according to an embodiment of the present disclosure.

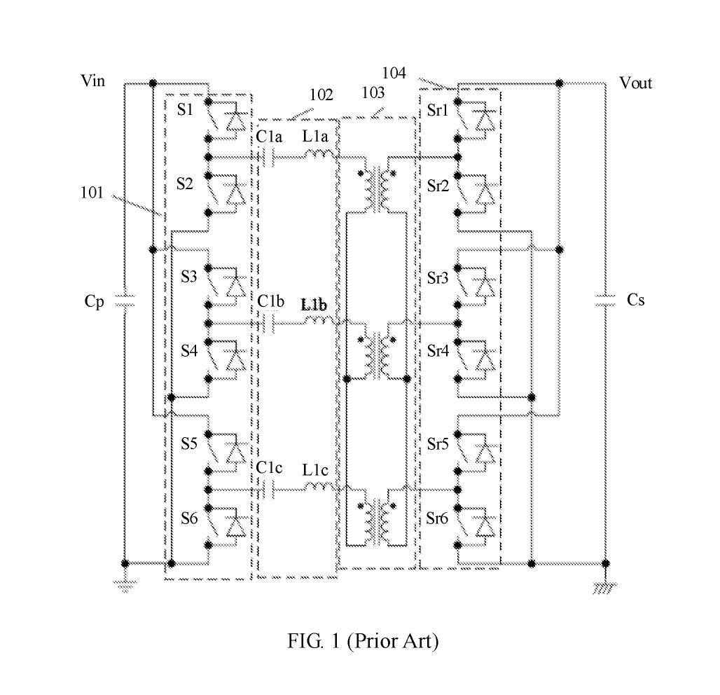

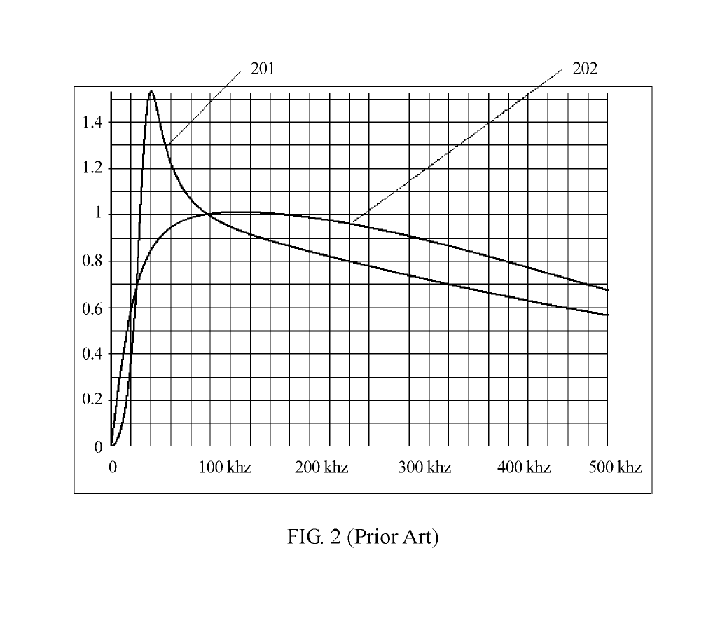

### DETAILED DESCRIPTION OF EMBODIMENTS

The bidirectional resonant conversion circuit provided in the embodiments can be used in a DC/DC part of communication power supplies, vehicle-mounted power supplies, photovoltaic inverters, or the like.

The bidirectional resonant conversion circuit provided in the embodiments can achieve the conversion of voltage bi-directionally without changing circuit structure.

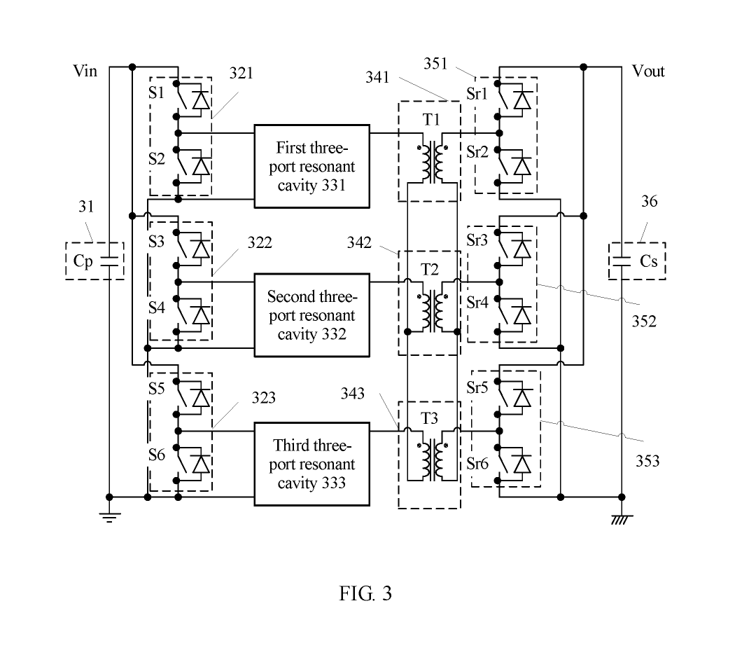

A bidirectional resonant conversion circuit provided in an embodiment of the present disclosure is described herein with reference to FIG. 3.

As shown in FIG. 3, the bidirectional resonant conversion circuit includes a primary capacitor 31, three primary side bridge arms 321, 322, 323, three three-port resonant cavities 331, 332, 333, three transformers 341, 342, 343, three secondary side bridge arms 351, 352, 353, and a secondary capacitor 36. For the convenience of description, the foregoing parts are named individually. It should be understood that the manner of naming these parts does not imply any particular order thereof or impose any limitations thereon.

The three primary side bridge arms included in the bidirectional resonant conversion circuit are first primary side bridge arm 321, second primary side bridge arm 322, and third primary side bridge arm 323.

The three three-port resonant cavities included in the bidirectional resonant conversion circuit are first three-port resonant cavity 331, second three-port resonant cavity 332, and third three-port resonant cavity 333.

The three transformers included in the bidirectional resonant conversion circuit are first transformer 341, second transformer 342, and third transformer 343.

The three secondary side bridge arms included in the bidirectional resonant conversion circuit are first secondary side bridge arm 351, second secondary side bridge arm 352, and third secondary side bridge arm 353.

Two ends of each primary side bridge arm are respectively connected to two ends of the primary capacitor 31.

That is, two ends of the first primary side bridge arm 321, two ends of the second primary side bridge arm 322, and two ends of the third primary side bridge arm 323 are separately connected to the two ends of the primary capacitor 31.

The three primary side bridge arms 321, 322, 323 are in a one-to-one correspondence with the three three-port resonant cavities 331, 332, 333. Primary-side windings of the three transformers 341, 342, 343 are in a one-to-one correspondence with the three three-port resonant cavities 331, 332, 333.

The first three-port resonant cavity 331 is corresponding to the first primary side bridge arm 321 and the first transformer 341, respectively. The second three-port resonant cavity 332 is corresponding to the second primary side bridge arm 322 and the second transformer 342, respectively. The third three-port resonant cavity 333 is corresponding to the third primary side bridge arm 323 and the third transformer 343, respectively.

Each three-port resonant cavity includes at least one group of inductor and capacitor. The inductor and capacitor included in the three-port resonant cavity determine a resonance frequency of the three-port resonant cavity.

Each three-port resonant cavity has three ports. A first port of the three-port resonant cavity is connected to a corresponding primary side bridge arm. A second port of the three-port resonant cavity is connected to a ground terminal of a corresponding primary side bridge arm. A third port of the three-port resonant cavity is connected to a corresponding transformer.

As shown in FIG. 3, a first port of the first three-port resonant cavity 331 is connected to the first primary side bridge arm 321. A second port of the first three-port resonant cavity 331 is connected to a ground terminal of the first primary side bridge arm 321. A third port of the first three-port resonant cavity 331 is connected to the first transformer 341. A first port of the second three-port resonant cavity 332 is connected to the second primary side bridge arm 322. A second port of the second three-port resonant cavity 332 is connected to a ground terminal of the second primary side bridge arm 322. A third port of the second three-port resonant cavity 332 is connected to the second transformer 342. A first port of the third three-port resonant cavity 333 is connected to the third primary side bridge arm 323. A second port of the third three-port resonant cavity 333 is connected to a ground terminal of the third primary side bridge arm 323. A third port of the third three-port resonant cavity 333 is connected to the third transformer 343.

Two ends of each secondary side bridge arm are respectively connected to two ends of the secondary capacitor 36.

Secondary-side windings of the three transformers 341, 342, 343 are in a one-to-one correspondence with the three secondary side bridge arms 351, 352, 353, and each transformer is connected to a corresponding secondary side bridge arm.

The first transformer 341 is connected to the first secondary side bridge arm 351, the second transformer 342 is connected to the second secondary side bridge arm 352, and the third transformer 343 is connected to the third secondary side bridge arm 353.

Two ends of the first secondary side bridge arm 351, two ends of the second secondary side bridge arm 352, and two ends of the third secondary side bridge arm 353 are respectively connected to the two ends of the secondary capacitor 36.

As shown in FIG. 3, each primary side bridge arm includes two semiconductor switching transistors that are connected in series in a same direction.

The first primary side bridge arm 321 includes a semiconductor switching transistor 51 and a semiconductor switching transistor S2 that are connected in series in a same direction. The second primary side bridge arm 322 includes a semiconductor switching transistor S3 and a semiconductor switching transistor S4 that are connected in series in a same direction. The third primary side bridge arm 323 includes a semiconductor switching transistor S5 and a semiconductor switching transistor S6 that are connected in series in a same direction.

A semiconductor switching transistor included in a primary side bridge arm may be a metal-oxide semiconductor field-effect transistor (MOSFET), or an insulated gate bipolar transistor (IGBT).

A node between the two semiconductor switching transistors that are in the primary side bridge arm and connected in series in a same direction is a first node. A node between the semiconductor switching transistor 51 and the semiconductor switching transistor S2 in the first primary side bridge arm 321 is a first node. A node between the semiconductor switching transistor S3 and the semiconductor switching transistor S4 in the second primary side bridge arm 322 is a first node. A node between the semiconductor switching transistor S5 and the semiconductor switching transistor S6 in the third primary side bridge arm 323 is a first node.

A first port of each three-port resonant cavity is connected to a first node of a corresponding primary side bridge arm. The first port of the first three-port resonant cavity 331 is connected to the first node of the first primary side bridge arm 321. The first port of the second three-port resonant cavity 332 is connected to the first node of the second primary side bridge arm 322. The first port of the third three-port resonant cavity 333 is connected to the first node of the third primary side bridge arm 323.

Each transformer includes a primary-side winding and a secondary-side winding. Each winding has two terminals, marked as dotted terminal and undotted terminal respectively according to conventional practice. In FIG. 3, the undotted terminals of the primary-side windings of the three transformers 341, 342, 343 are connected together. Alternatively, the dotted terminals of the primary-side windings of the three transformers may be connected together. Also shown in FIG. 3, the undotted terminals of the secondary-side windings of the three transformers are connected together. Alternatively, the dotted terminals of the secondary-side windings of the three transformers may be connected together.

A third port of each three-port resonant cavity is connected to a primary-side winding of a corresponding transformer. The third port of the first three-port resonant cavity 331 is connected to a primary-side winding of the first transformer 341. The third port of the second three-port resonant cavity 332 is connected to a primary-side winding of the second transformer 342. The third port of the third three-port resonant cavity 333 is connected to a primary-side winding of the third transformer 343.

Each secondary side bridge arm includes two semiconductor switching transistors that are connected in series in a same direction, and a node between two semiconductor switching transistors that are on a secondary side bridge arm and connected in series in a same direction is a second node.

The first secondary side bridge arm 351 includes two semiconductor switching transistors Sr1 and Sr2 that are connected in series in a same direction, and a node between the semiconductor switching transistors Sr1 and Sr2 is a second node. The second secondary side bridge arm 352 includes two semiconductor switching transistors Sr3 and Sr4 that are connected in series in a same direction, and a node between the semiconductor switching transistors Sr3 and Sr4 is a second node. The third secondary side bridge arm 353 includes two semiconductor switching transistors Sr5 and Sr6 that are connected in series in a same direction, and a node between the semiconductor switching transistors Sr5 and Sr6 is a second node.

A semiconductor switching transistor included on a secondary side bridge arm may be a metal-oxide semiconductor field-effect transistor (MOSFET), or an insulated gate bipolar transistor (IGBT).

An electrical connection structure between the transformer and the secondary side bridge arm is that the secondary-side winding of each transformer is connected to a second node of a corresponding secondary side bridge arm. The secondary-side winding of the first transformer 341 is connected to the second node of the first secondary side bridge arm 351. The secondary-side winding of the second transformer 342 is connected to the second node of the second secondary side bridge arm 352. The secondary-side winding of the third transformer 343 is connected to the second node of the third secondary side bridge arm 353.

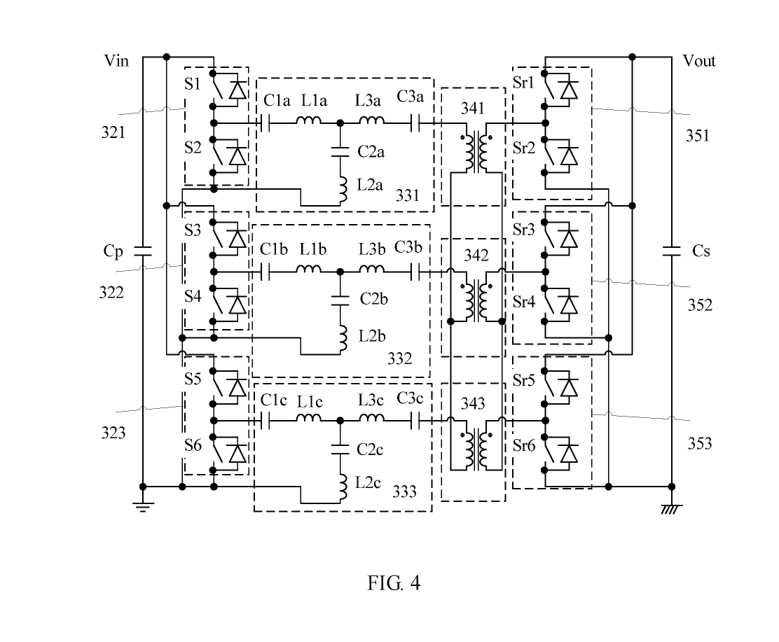

In a bidirectional resonant conversion circuit according to an embodiment of the present disclosure, a specific circuitry structure of the three-port resonant cavity is shown in FIG. 4. Each three-port resonant cavity includes a first group of inductor and capacitor, a second group of inductor and capacitor, and a third group of inductor and capacitor. The first three-port resonant cavity 331 is used as an example for description.

The first three-port resonant cavity 331 includes a first group of inductor and capacitor, a second group of inductor and capacitor, and a third group of inductor and capacitor. The first group of inductor and capacitor includes a first inductor L1a and a first capacitor C1a that are mutually connected in series. The second group of inductor and capacitor includes a second inductor L2a and a second capacitor C2a that are mutually connected in series. The third group of inductor and capacitor includes a third inductor L3a and a third capacitor C3a that are mutually connected in series.

A first end of the first group of inductor and capacitor is used as the first port of the three-port resonant cavity, so that the first three-port resonant cavity 331 is connected to the first node of the first the first primary side bridge arm 321 by using the first port.

In the example shown in FIG. 4, the first end of the first group of inductor and capacitor is a first end of the first capacitor C1a. This means that the first end of the first capacitor C1a is connected to the first node of the first primary side bridge arm 321.

A second end of the first capacitor C1a is connected to a first end of the first inductor L1a when the first end of the first group of inductor and capacitor is the first end of the first capacitor C1a.

A second end of the first inductor L1a is used as a second end of the first group of inductor and capacitor.

It should be noted that, in this embodiment, the example in which the first end of the first group of inductor and capacitor is the first end of the first capacitor C1a is used for exemplary description, and is not intended for limitation. For another example, the first end of the first group of inductor and capacitor is the first end of the first inductor L1a. In this case, the second end of the first inductor L1a is connected to the first end of the first capacitor C1a, and the second end of the first capacitor C1a is used as the second end of the first group of inductor and capacitor.

The second group of inductor and capacitor includes the second inductor L2a and the second capacitor C2a that are connected in series.

A first end of the second group of inductor and capacitor is used as the second port of the three-port resonant cavity, so that the first three-port resonant cavity 331 is connected to the ground terminal of the first primary side bridge arm 321 by using the second port.

In this embodiment, FIG. 4 is used as an example, and the first end of the second group of inductor and capacitor is a first end of the second inductor L2a, that is, the first end of the second inductor L2a is connected to the ground terminal of the first primary side bridge arm 321.

A second end of the second inductor L2a is connected to a first end of the second capacitor C2a when the first end of the second group of inductor and capacitor is the first end of the second inductor L2a.

A second end of the second capacitor C2a is used as a second end of the second group of inductor and capacitor.

It should be noted that, in this embodiment, the example in which the first end of the second group of inductor and capacitor is the first end of the second inductor L2a is used for exemplary description, and is not intended for limitation. For another example, the first end of the second group of inductor and capacitor is the first end of the second capacitor C2a. In this case, the first end of the second capacitor C2a is connected to the ground terminal of the first primary side bridge arm 321, the second end of the second capacitor C2a is connected to the first end of the second inductor L2a, and the second end of the second inductor L2a is used as the second end of the second group of inductor and capacitor.

The third group of inductor and capacitor includes the third inductor L3a and the third capacitor C3a that are mutually connected in series.

A first end of the third group of inductor and capacitor is used as the third port of the three-port resonant cavity, so that the first three-port resonant cavity 331 is connected to the first transformer 341 by using the third port.

In this embodiment, FIG. 4 is used as an example, and the first end of the third group of inductor and capacitor is a first end of the third capacitor C3a, that is, the first end of the third capacitor C3a is connected to the first transformer 341.

A second end of the third capacitor C3a is connected to a first end of the third inductor L3a when the first end of the third group of inductor and capacitor is the first end of the third capacitor C3a.

A second end of the third inductor L3a is used as a second end of the third group of inductor and capacitor.

It should be noted that, in this embodiment, the example in which the first end of the third group of inductor and capacitor is the first end of the third capacitor C3a is used for exemplary description, and is not intended for limitation. For another example, the first end of the third group of inductor and capacitor is the first end of the third inductor. In this case, the second end of the third inductor is connected to the first end of the third capacitor C3a, and the second end of the third capacitor C3a is used as the second end of the third group of inductor and capacitor.

As shown in FIG. 4, the second end of the first group of inductor and capacitor, the second end of the second group of inductor and capacitor, and the second end of the third group of inductor and capacitor are connected to each other.

In this example, for specific description of the second three-port resonant cavity 332 and the third three-port resonant cavity 333, refer to the specific description of the first three-port resonant cavity 331, which is not described in detail herein.

With reference to FIG. 4, the following describes a current direction of the bidirectional resonant conversion circuit provided in this embodiment.

As shown in FIG. 4, a direct current voltage Vin is input to the primary side bridge arms 321, 322, 323. Two switching transistors included in each primary side bridge arm are alternately connected or disconnected, so that the input direct current voltage is converted to square waves, and the square waves are fed into the three-port resonant cavities 331, 332, 333.

Then each of the three-port resonant cavities transmits an output voltage to a corresponding secondary side bridge arm by using a transformer connected in between.

Two switching transistors included in each secondary side bridge arm are alternately connected or disconnected, so that the periodically output voltage waveform is rectified, and a direct current voltage Vout is output.

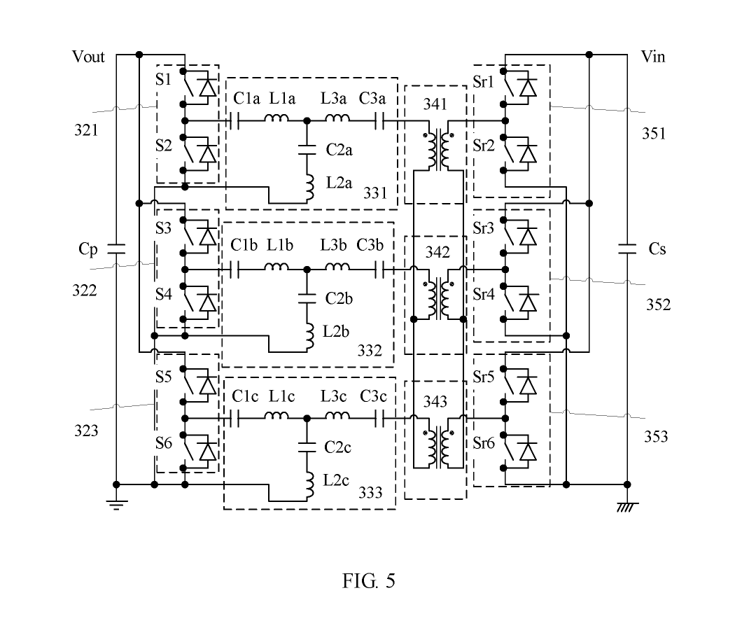

Refer now to FIG. 5 for a reversed input/output direction. A difference between FIG. 4 and FIG. 5 lies in that in FIG. 4, the direct current voltage Vin is input to the primary side bridge arm, whereas in FIG. 5, the direct current voltage Vin is input to the secondary side bridge arm.

For a specific circuit structure of the bidirectional resonant conversion circuit shown in FIG. 5, refer to the description of FIG. 4, and details are not described herein.

As shown in FIG. 5, a direct current voltage Vin is input to the secondary side bridge arms. Two switching transistors included in each primary side bridge arm are alternately connected or disconnected, so that the input direct current voltage is converted to square waves. The secondary side bridge arms feed the square waves to the three-port resonant cavities through the transformers. Then, each three-port resonant cavity transmits an output voltage to a corresponding primary side bridge arm. Two switching transistors included in each primary side bridge arm are alternately connected or disconnected, so that the periodically output voltage waveform is rectified, and direct current voltage Vout is output.

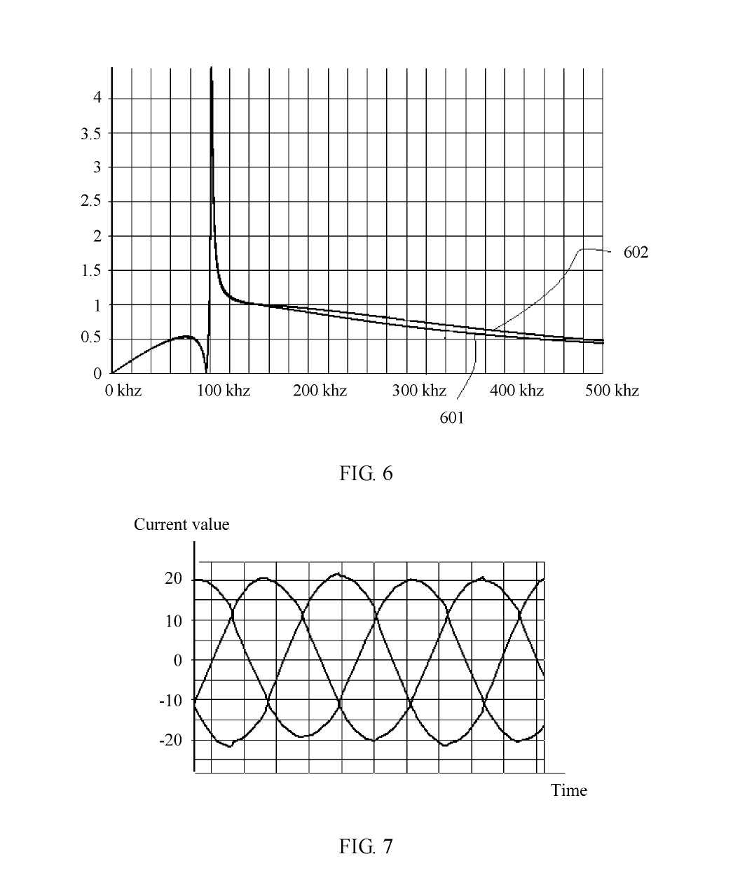

As shown in FIG. 6, there are advantages of this embodiment of the present disclosure. When the bidirectional resonant conversion circuit provided in this embodiment is used, a rectification gain curve 601 and an inverse gain curve 602 are almost identical. Because the rectification gain curve 601 and the inverse gain curve 602 of the bidirectional resonant conversion circuit are almost identical, bidirectional conversion can be easily implemented. Therefore, controlling is easy and reliability is high. In addition, dotted terminals or undotted terminals of transformers of the bidirectional resonant conversion circuit provided in this embodiment are connected, so that natural current sharing can be implemented according to the bidirectional resonant conversion circuit provided in this embodiment, thereby avoiding adding an extra current sharing circuit, reducing costs, and increasing the reliability.

For a waveform diagram of a current output by the bidirectional resonant conversion circuit provided in this embodiment, refer to FIG. 7.

According to the bidirectional resonant conversion circuit provided in this embodiment, an output ripple current can be greatly reduced, a quantity of output filter capacitors is decreased, costs are reduced, and a module size is reduced.

In addition, conversion efficiency of a bidirectional converter is improved by using the bidirectional resonant conversion circuit provided in this embodiment, thereby improving product competitiveness.

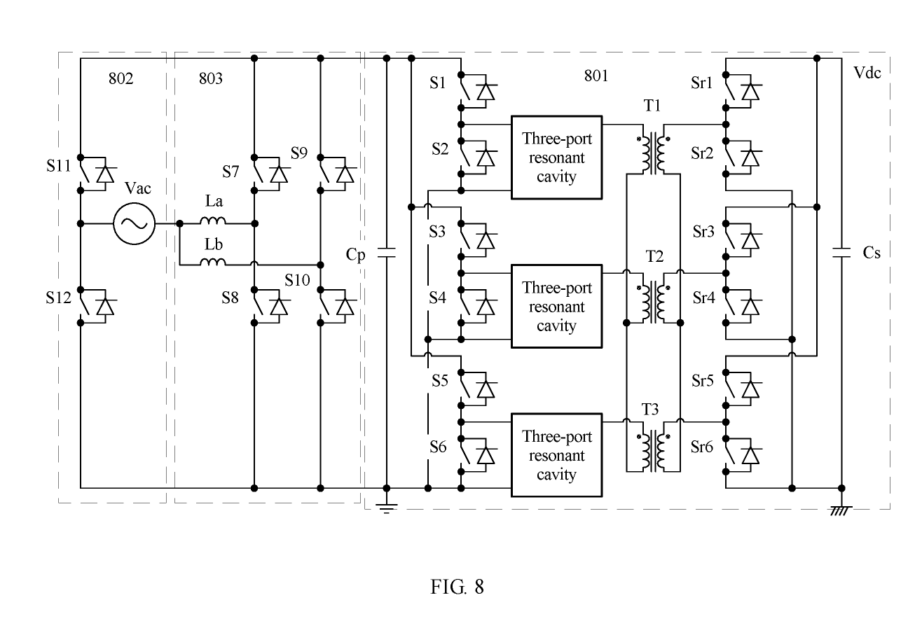

An embodiment of the present disclosure further provides a converter. As shown in FIG. 8, the converter includes a power factor correction (PFC) module and a bidirectional resonant conversion circuit 801.

The PFC module and the bidirectional resonant conversion circuit 801 are connected in series.

As shown in FIG. 8, the PFC module includes a power supply module 802 and a power module 803. The power supply module 802 is connected to the power module 803, and the power supply module 802 is configured to provide electric energy for the power module 803.

The power module 803 includes at least one PFC circuit, each PFC circuit includes one inductor and one pair of first semiconductor switching transistors. A first end of the inductor is connected to the power supply module 802, and a second end of the inductor is separately connected to two ends of a primary capacitor through the first semiconductor switching transistors.

FIG. 8 is used as an example. In this embodiment, an example in which the power module 803 includes two PFC circuits is used as an example for description. That is, in this embodiment, the power module 803 includes a first PFC circuit and a second PFC circuit.

The first PFC circuit includes an inductor La and a pair of first semiconductor switching transistors S7 and S8.

A first end of the inductor La is connected to the power supply module 802, and a second end of the inductor La is separately connected to the two ends of the primary capacitor Cp through the switching transistors S7 and S8.

The second PFC circuit includes an inductor Lb and a pair of first semiconductor switching transistors S9 and S10.

A first end of the inductor Lb is connected to the power supply module 802, and a second end of the inductor Lb is separately connected to the two ends of the primary capacitor Cp through the switching transistors S9 and S10.

The power supply module 802 includes an alternating current power supply Vac and two second semiconductor switching transistors S11 and S12.

A first end of each second semiconductor switching transistor is connected to the alternating current power supply Vac, and a second end of each second semiconductor switching transistor is connected to one of the pair of first semiconductor switching transistors of the power module 803.

As shown in FIG. 8, a first end of the S11 is connected to the alternating current power supply Vac, and a second end of the S11 is connected to one of the first semiconductor switching transistors S7 and S8. A first end of the S12 is connected to the alternating current power supply Vac, and a second end of the S12 is connected to one of the first semiconductor switching transistors S9 and S10. For a specific circuit structure of the bidirectional resonant conversion circuit 801, refer to FIGS. 3 to 5, and details are not described in this embodiment.

A bidirectional conversion between an alternating current (AC) voltage and a direct current (DC) voltage can be implemented by using the converter provided in this embodiment.

A field to which the converter is applied is not limited in this embodiment, as long as a complete set of bidirectional conversion between an alternating current (AC) voltage and a direct current (DC) voltage can be implemented by using the converter. For example, the converter provided in this embodiment can be used in a vehicle-mounted charging system, and can also be used a field of communications energy, photovoltaic inverters, or the like.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A bidirectional resonant conversion circuit, comprising:
a primary capacitor, three primary side bridge arms, three resonant cavities, three transformers, three secondary side bridge arms, and a secondary capacitor;
wherein one primary side bridge arm, one resonant cavity, one transformer and one secondary side bridge arm form a group; wherein in each group,
the primary side bridge arm has a first terminal and a ground terminal that are respectively connected to two ends of the primary capacitor;
the resonant cavity has a first port that is coupled to the primary side bridge arm, a second port that is connected to the ground terminal of the primary side bridge arm, and a third port that is coupled to a primary-side winding of the transformer;
the secondary side bridge arm has a first terminal and a ground terminal that are respectively connected to two ends of the secondary capacitor; and
the secondary side bridge arm is coupled to a secondary-side windings of the transformer.

2. The bidirectional resonant conversion circuit according to claim 1, wherein each resonant cavity comprises a first group of inductor and capacitor, a second group of inductor and capacitor, and a third group of inductor and capacitor, wherein
the first group of inductor and capacitor comprises a first inductor and a first capacitor that are connected in series, a first end of the first group of inductor and capacitor is used as the first port of the resonant cavity, and the first end of the first group of inductor and capacitor is a first end of the first capacitor or a first end of the first inductor;
the second group of inductor and capacitor comprises a second inductor and a second capacitor that are connected in series, a first end of the second group of inductor and capacitor is used as the second port of the resonant cavity, and the first end of the second group of inductor and capacitor is a first end of the second capacitor or a first end of the second inductor;
the third group of inductor and capacitor comprises a third inductor and a third capacitor that are connected in series, a first end of the third group of inductor and capacitor is used as the third port of the resonant cavity, and the first end of the third group of inductor and capacitor is a first end of the third capacitor or a first end of the third inductor; and
a second end of the first group of inductor and capacitor, a second end of the second group of inductor and capacitor, and a second end of the third group of inductor and capacitor are connected to each other.

3. The bidirectional resonant conversion circuit according to claim 1, wherein each primary side bridge arm comprises two switching transistors that are connected in series in a same direction, and wherein in each group, the first port of the resonant cavity is connected to a node between the two switching transistors in the primary side bridge arm.

4. The bidirectional resonant conversion circuit according to claim 2, wherein each primary side bridge arm comprises two switching transistors that are connected in series in a same direction, and wherein in each group, the first port of the resonant cavity is connected to a node between the two switching transistors in the primary side bridge arm.

5. The bidirectional resonant conversion circuit according to claim 1, wherein each secondary side bridge arm comprises two switching transistors that are connected in series in a same direction, and wherein in each group, the secondary-side winding of the transformer is connected to a node between the two switching transistors in the secondary side bridge arm.

6. The bidirectional resonant conversion circuit according to claim 2, wherein each secondary side bridge arm comprises two switching transistors that are connected in series in a same direction, and wherein in each group, the secondary-side winding of the transformer is connected to a node between the two switching transistors in the secondary side bridge arm.

7. The bidirectional resonant conversion circuit according to claim 3, wherein each secondary side bridge arm comprises two switching transistors that are connected in series in a same direction, and wherein in each group, the secondary-side winding of the transformer is connected to a node between the two switching transistors in the secondary side bridge arm.

8. The bidirectional resonant conversion circuit according to claim 4, wherein each secondary side bridge arm comprises two switching transistors that are connected in series in a same direction, and wherein in each group, the secondary-side winding of the transformer is connected to a node between the two switching transistors in the secondary side bridge arm.

9. The bidirectional resonant conversion circuit according to claim 3, wherein the switching transistor is a metal-oxide semiconductor field-effect transistor (MOSFET), or an insulated gate bipolar transistor (IGBT).

10. The bidirectional resonant conversion circuit according to claim 4, wherein the switching transistor is a metal-oxide semiconductor field-effect transistor (MOSFET), or an insulated gate bipolar transistor (IGBT).

11. The bidirectional resonant conversion circuit according to claim 5, wherein the switching transistor is a metal-oxide semiconductor field-effect transistor (MOSFET), or an insulated gate bipolar transistor (IGBT).

12. The bidirectional resonant conversion circuit according to claim 6, wherein the switching transistor is a metal-oxide semiconductor field-effect transistor (MOSFET), or an insulated gate bipolar transistor (IGBT).

13. The bidirectional resonant conversion circuit according to claim 7, wherein the switching transistor is a metal-oxide semiconductor field-effect transistor (MOSFET), or an insulated gate bipolar transistor (IGBT).

14. The bidirectional resonant conversion circuit according to claim 8, wherein the switching transistor is a metal-oxide semiconductor field-effect transistor (MOSFET), or an insulated gate bipolar transistor (IGBT).

15. The bidirectional resonant conversion circuit according to claim 1,
wherein in each group, each of the primary-side winding and the secondary-side winding of the transformer comprises a dotted terminal and an undotted terminal, the third port of the resonant cavity is connected to the dotted terminal of the primary-side winding of the transformer; and
wherein the undotted terminals of the primary-side windings of the three transformers are connected together, and the undotted terminals of the secondary-side windings of the three transformers are connected together.

16. The bidirectional resonant conversion circuit according to claim 2,
wherein in each group, each of the primary-side winding and the secondary-side winding of the transformer comprises a dotted terminal and an undotted terminal, the third port of the resonant cavity is connected to the dotted terminal of the primary-side winding of the transformer; and
wherein the undotted terminals of the primary-side windings of the three transformers are connected together, and undotted terminals of the secondary-side windings of the three transformers are connected together.

17. The bidirectional resonant conversion circuit according to claim 5,
wherein in each group, each of the primary-side winding and the secondary-side winding of the transformer comprises a dotted terminal and an undotted terminal, the third port of the resonant cavity is connected to the dotted terminal of the primary-side winding of the transformer, and the dotted terminal of the secondary-side winding of the transformer is connected to the node between the two switching transistors in the secondary side bridge arm; and
wherein the undotted terminals of the primary-side windings of the three transformers are connected together, and undotted terminals of the secondary-side windings of the three transformers are connected together.

18. The bidirectional resonant conversion circuit according to claim 6,
wherein in each group, each of the primary-side winding and the secondary-side winding of the transformer comprises a dotted terminal and an undotted terminal, the third port of the resonant cavity is connected to the dotted terminal of the primary-side winding of the transformer, and the dotted terminal of the secondary-side winding of the transformer is connected to the node between the two switching transistors in the secondary side bridge arm; and
wherein the undotted terminals of the primary-side windings of the three transformers are connected together, and undotted terminals of the secondary-side windings of the three transformers are connected together.

19. The bidirectional resonant conversion circuit according to claim 1, further comprising a power factor correction (PFC) module; wherein the bidirectional resonant conversion circuit and the PFC module are connected in series to form a converter;
wherein the PFC module comprises:
a power supply module, and a power module connected to the power supply module;
wherein the power supply module is configured to provide electric energy for the power module;
wherein the power module comprises at least one PFC circuit, each PFC circuit comprises one inductor and two switching transistors that are connected in series in a same direction, a first end of the inductor is connected to the power supply module, a second end of the inductor is connected to a node between the two switching transistors, and two other ends of the switching transistors are respectively connected to the two ends of the primary capacitor of the bidirectional resonant conversion circuit; and
wherein the power supply module comprises an alternating current power supply and two switching transistors that are connected in series in a same direction, one end of the alternating current power supply is connected to a node between the two switching transistors, another end of the alternating current power supply is connected to the power module, and two other ends of the switching transistors are respectively connected to the two ends of the primary capacitor of the bidirectional resonant conversion circuit.
